(19) United States
(12) Patent Application Publication
(10) Pub. No.: US 2024/0166382 A1
(43) Pub. Date: May 23, 2024

(54) DRONE PARACHUTE SYSTEMS FOR DELIVERY OR RECOVERY

(71) Applicant: AVSS - AERIAL VEHICLE SAFETY SOLUTIONS INC., Quispamsis (CA)

(72) Inventors: Joshua BOUDREAU, Ottawa (CA); Ashim PANTA, Melbourne (AU); Joshua OGDEN, Quispamsis (CA); Reay O'DARE, Melbourne (AU); Ryan DES COTES, Ottawa (CA); Robert D. WATTERS, Ottawa (CA); Joseph Luc BOUCHER, Ottawa (CA); Thomas MOORE, Ottawa (CA); Michael SIROIS, Ottawa (CA)

(21) Appl. No.: 18/282,054

(22) PCT Filed: Mar. 14, 2022
(86) PCT No.: PCT/IB2022/052290

§ 371 Date: Sep. 14, 2023

Related U.S. Application Data
(63) Continuation-in-part of application No. PCT/IB2022/052290, filed on Mar. 14, 2022.
(60) Provisional application No. 63/161,302, filed on Mar. 15, 2021.

(51) Int. Cl. B64U 10/50; B64D 1/08; B64D 17/02; B64D 17/34; B64D 17/80; B64U 101/64

(52) U.S. Cl. CPC B64U 10/50; B64D 1/08; B64D 17/02; B64D 17/34; B64D 17/80; B64U 2101/64; B64U 2201/10

(57) ABSTRACT

A system for payload delivery and drone recovery, wherein the system functions with the use of a lightweight parachute and a directional control module. The system can include a drop system for payload delivery, wherein the drop system releases the parachute and payload upon reaching a target site. The system can also include a recovery system, wherein the recovery system deploys the parachute and steers the failed drone to a target site. A lightweight ram-air parachute is used to provide a lighter steerable parachute system.

### FIELD

The present specification relates generally to uncrewed aerial vehicles and more particularly relates to a parachute system for delivery of a payload.

### BACKGROUND

Unmanned aerial vehicles (UAV) or drones may be used to deliver parcels or other objects. The present disclosure relates to parachute systems that may be used to enable parcel delivery. Further, the parachute systems described herein may be used for emergency-controlled descent for a drone that has malfunctioned or expended its power supply or where there is a preference for a static (off) rotor descent.

Known parachute systems for controlled delivery of a payloads are large, heavy, and have relatively low accuracy.

### SUMMARY

Described herein and in accompanying documents are parachute systems including parachutes, controllers, sensors, and actuators that provide controlled descent of a payload or drone. Further described herein and in accompanying documents are ram-air parachutes of various constructions that reduce or minimize weight or required storage volume while providing acceptable or improved unfurling/inflating capabilities.

In accordance with an aspect of the invention, there is provided a system comprising a frame, a parachute connected to the frame by a set of lines or tension elements, an actuator connected to the frame, a control line connecting the actuator to a directional control point of the parachute and a sensor connected to the frame. The sensor is for capturing a signal related to a target site. A controller is provided that is connected to the actuator and the sensor, which is configured to control the actuator to adjust tension on the control line of the parachute in order to change a direction of travel of the apparatus in response to the signal captured by the sensor. An attachment component is also provided which is connected to the frame. The attachment component is configured for removably attaching an object to the frame that is to be carried by the parachute to the target site.

The attachment component can be configured to removably attach a drone payload to the frame, wherein the apparatus provides guided delivery of the payload when dropped from the drone. Alternatively, the attachment component can be a container lid and a clip connected to the container lid to removably attach a container body to the container lid. The container lid can be reversible to allow storage of the apparatus in the container body. Alternatively, the attachment component can be a container body a clip connected to the container body to removably attach a container lid to the container body. The container lid can include an engagement feature to engage with a complementary engagement feature on an arm that extends from a drone to releasably secure the system to the drone. The attachment component can also have a set of opposing clips arranged to engage a knob of a parcel securement assembly. The parcel securement assembly can include linear tension members arranged to encompass a parcel. The parcel can also include corner brackets attached to the linear tension members to fit over corners of the parcel. The frame can have an engagement feature to engage with a complementary engagement feature on an arm that extends from a drone to releasably secure the apparatus to the drone. The attachment component can further be configured to removably attach a drone to the frame, where the system is to provide guided recovery of the drone. The attachment component can include an arm with an engagement feature to engage with a complementary engagement feature on the drone to removably secure the system to the drone.

The sensor can be an inertial sensor, barometric pressure sensor, a navigation system signal receiver, photosensor, camera, or combination of such. The controller can be programmed to use the signal to continuously track in real time the target site and correspondingly control the actuator continuously and in real time to actuate the control line of the parachute to maintain the direction of travel of the apparatus to the target site. The system can also have a battery connected to the controller, the sensor, and the actuator.

In accordance with another aspect of the invention, there is provided a steerable parachute system for use with a drone comprising a directional control module. The directional control module has an enclosure that supports a sensor that is for capturing a signal associated with a target site. A controller is connected to the sensor for determining a direction of travel in response to the signal. An actuator is coupled to the controller, and the actuator is responsive to control signals from the controller. The system also has an attachment component for securing a payload to the enclosure. The parachute is connectable to the directional control module, having at least one tension element connected to the actuator for steering the parachute during controlled descent towards a location relative to the target site. The payload can be a drone. The payload can also be a parcel.

The steerable parachute system can also have a drop system to provide guided delivery of a parcel. The drop system has a mounting bracket for securing to the drone with a chassis attached to one side of the mounting bracket, used to support a drop system control module and a jaw for releasably securing one side of the directional control module. The drop system can also have a securing arm attached to the opposite side of the mounting bracket to secure the opposite side of the directional control module. The attachment component can be at least one linear tension member for securing a parcel. The system can have a swivel so that the parcel can rotate freely independently from the directional control module.

The steerable parachute system can also have a recovery system to provide for guided recovery of a failed drone. The recovery system can have deployment mechanism that deploys upon detection of drone failure. The deployment mechanism can be attached to the directional control module and the parachute, as well as at least one mounting bracket to secure the directional control module to the drone. The deployment mechanism can be a spring. The deployment mechanism can be a comprises a pyrotechnic mechanism.

In accordance with another aspect of the invention, there is provided a directional control module that provided controlled descent towards a location relative to the target site. The directional control module comprises an enclosure. The enclosure supports a sensor for capturing a signal associated with a target site. The enclosure also supports a controller connected to the sensor that determines a direction of travel in response to the signal. The enclosure further supports an actuator responsively coupled to the controller. The actuator is connectable to at least one tension element of a parachute. The actuator can have at least one servo pulley. The enclosure can have at least one shackle for securing at least one of said tension elements on the parachute.

In accordance with another aspect of the invention, there is provided a ram-air parachute comprising a canopy structure formed of a plurality of cells. A cell of the plurality of cells includes walls of a first material. The canopy structure further includes an inflation portion made of a second material. The first material has a lower mass per unit area than the second material, and the second material is less self-adhering than the first material. The inflation portion is positioned at a perimeter of the canopy structure to initiate inflation of the cell and separation of the walls made of the first material when the canopy structure is deployed. The walls of the first material can include portions of a top and bottom wall of the canopy structure and said inflation portion comprises a portion of a side wall of the canopy structure. The portions of a top and bottom wall of the canopy structure can include first triangular portions having vertices at a center and corners of the canopy structure. The inflation portion can include second triangular portions having vertices at the center and corners of the canopy structure. The inflation portion can further include a linear portion extending between opposite corners of the canopy structure. The inflation portion can have a corner portion of the side wall of the canopy structure. The inflation portion can have a middle portion of the side wall of the canopy structure. The inflation portion can have an entire side wall of the canopy structure. The first material can be an ultra-high molecular weight polyethylene. The second material can be nylon.

In accordance with another aspect of the invention, a parachute is provided. The parachute has a first portion of a first material and an inflation portion of the first material. The first material is self-adhering, and at least some of the inflation portion is calendared.

### BRIEF DESCRIPTION OF THE DRAWINGS

Described herein and in accompanying documents are parachute systems including controllers, sensors, and actuators that provide controlled descent of a payload or drone. Further described herein and in accompanying documents are ram-air parachutes of various composite constructions that reduce or minimize weight or required storage volume while providing acceptable or improved unfurling/inflating capabilities.

FIG. 1 is a view of an embodiment of a steerable parachute after it has been released from a drone and the parachute has deployed.

FIG. 2 is a view of another embodiment a steerable parachute with a packed parachute.

FIG. 3 is an additional example of an attachment component to secure a payload to a parachute frame to provide controlled and guided delivery of the payload when dropped from a drone.

FIG. 4 is an additional example of an attachment component to secure a payload to a parachute frame to provide controlled and guided delivery of the payload when dropped from a drone.

FIG. 5 is an additional example of an attachment component to secure a payload to a parachute frame to provide controlled and guided delivery of the payload when dropped from a drone.

FIG. 6 is an additional example of an attachment component to secure a payload to a parachute frame to provide controlled and guided delivery of the payload when dropped from a drone.

FIG. 7 is an additional example of an attachment component to secure a payload to a parachute frame to provide controlled and guided delivery of the payload when dropped from a drone.

FIG. 8 is an additional example of an attachment component to secure a payload to a parachute frame to provide controlled and guided delivery of the payload when dropped from a drone.

FIG. 9 is an example embodiment of a steerable parachute system that includes an attachment component that is configured to removably attach to a drone.

FIG. 10 is a block diagram of an example drone carrying an example parachute system that holds a payload.

FIG. 11 is an example parachute that may be used with the steerable parachute system.

FIG. 12 is an example parachute that may be used with the steerable parachute system.

FIG. 13 is an example parachute that may be used with the steerable parachute system.

FIG. 14 is an example parachute that may be used with the steerable parachute system.

FIG. 15 is an example parachute that may be used with the steerable parachute system.

FIG. 16 is a top isometric view of an embodiment of a directional control module on the steerable parachute system.

FIG. 17 is a front view of an embodiment of a directional control module on the steerable parachute system.

FIG. 18 is a rear isometric view of an embodiment of a directional control module on the steerable parachute system.

FIG. 19 is a bottom isometric view of an embodiment of a drop module connected to a directional control module on the steerable parachute system.

FIG. 20 is a top isometric view of an embodiment of a drop module connected to a directional control module on the steerable parachute system.

FIG. 21 is a side view of an embodiment of a drop module.

FIG. 22 is a sectional view of the drop module of FIG. 21 along the plane “A-A” of FIG. 21.

FIG. 23 is a bottom isometric view of an embodiment of a steerable parachute system for payload delivery.

FIG. 24 is a perspective of an embodiment of a steerable parachute system for payload delivery, carrying a payload.

FIG. 25 is a partial isometric view of a steerable parachute system showing components of a parachute pod.

FIG. 26 is an isometric view of an embodiment of a steerable parachute system for drone recovery.

FIG. 27 is a first side view of a drone mounting bracket for drone recovery.

FIG. 28 is a second side view of a drone mounting bracket for drone recovery.

### DETAILED DESCRIPTION

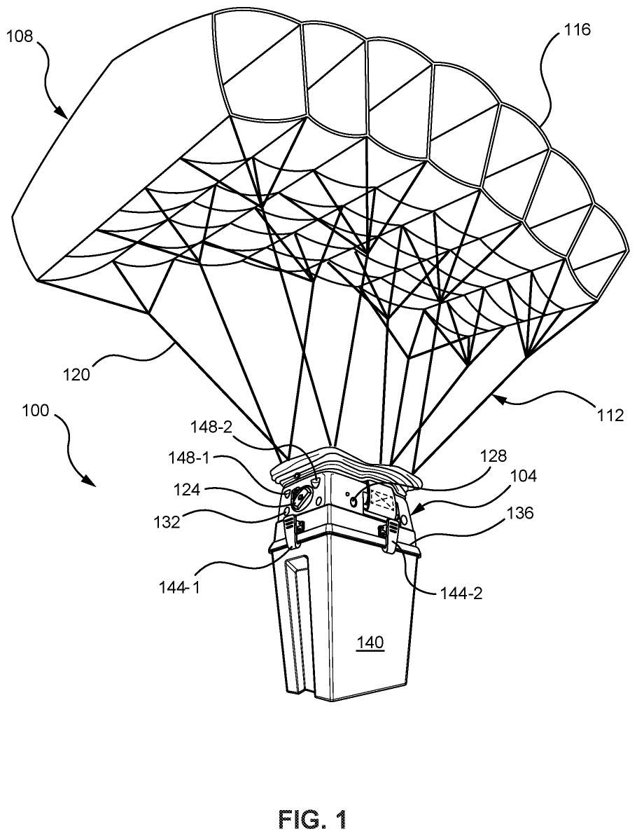

FIG. 1 shows an example parachute system 100 that includes a frame 104 and a parachute 108. The frame 104 may include a housing, container, or other physical structure that is attached to the parachute 108 by a set of lines 112.

The parachute 108 may be a ram-air parachute, parafoil, or other controllable parachute. The parachute 108 may include a canopy structure 116 that carries a load to be descended using the lines 112. The canopy structure 116 may be made from fabric or other material arranged as a plurality of cells. A control line 120 may be connected to the canopy structure 116, such as at a corner or edge, to apply or relax tension to maneuver the parachute 108. Multiple controls lines 120 may be so provided.

The frame 104 may carry an actuator 124, a sensor 128, and a controller 132. For example, the actuator 124, sensor 128, and controller 132 may be positioned inside or otherwise at a housing that forms the frame 104, as depicted. The actuator 124 and sensor 128 are electrically connected to the controller 132. The controller 132 takes input from the sensor 128 and provides control output to the actuator 124.

An actuator 124 may be connected to a control line 120 to control the length of the line 120 and thus a directional input to the canopy structure 18. An example actuator 124 is an electric motor with a pulley, around which the control line is wound. Each control line 120 may be provided with its own actuator 124, which may be independently controllable.

The sensor 128 may include an inertial sensor, barometric pressure sensor, a navigation system signal receiver, photosensor, camera, lidar (laser imaging detection and range finding) or combination of such. Any number of sensors 128 may be provide. In various examples an array of sensors 128 is provided. The sensor 128 can be passive or active. A photosensor is an example of a passive sensor. A photosensor used with a light source to augment the sensing capability is an example of an active sensor.

The controller 132 is configured to take a signal from the sensor 128 and process the signal to determine whether and to what degree the actuator 124 is to wind or unwind the control line 120 to change the direction of travel of the parachute system 100 is it descends.

The controller 132 may be programmed to use the sensor's 128 signal to continuously track in real time a target site where the parachute system 100 is to be dropped. The controller 132 may control the actuator 124 to continuously and in real time actuate the control line 120 of the parachute 108 to maintain a direction of travel of the parachute system 100 to the target site.

The controller 132 may include a microcontroller, a microprocessor, a field-programmable gate array (FPGA), an application-specific integrated circuit (ASIC), or a similar device capable of executing instructions. The controller 132 may cooperate with a non-transitory machine-readable medium, which may include an electronic, magnetic, optical, or other physical storage device that encodes instructions. The machine-readable medium may include, for example, random access memory (RAM), read-only memory (ROM), electrically erasable programmable read-only memory (EEPROM), flash memory, or similar device.

Instructions may be directly executed, such as a binary file, and/or may include interpretable code, bytecode, source code, or similar instructions that may undergo additional processing to be executed. All of such examples may be considered executable instructions.

In various examples, the sensor 128 may include a camera aimed towards the ground. The controller 132 may perform image processing to track image features of a target site. Image processing may determine apparent movement of the target site in the image and the controller 132 may compute a corresponding actuator signal, so that the image features of the target site are maintained at a suitable apparent location in the image.

In the same or other examples, the sensor 128 may include an accelerometer that provides an acceleration, velocity, and/or position signal. The controller 132 may compare such to a known position of a target site and compute a corresponding actuator signal. A sensor such as an anemometer, including those using various designs such as propeller, ultrasonic, or lidar, can be used to measure wind speed and direction for input into the controller 132.

In the same or other examples, the sensor 128 may include a barometric pressure sensor that is used by the controller to determine altitude of the parachute system 100 as it descends.

The parachute system 100 further includes an attachment component 136 connected to the frame 104. The attachment component 136 is configured to removably attach an container body 140 to the frame 104. Such a container body 140 is to be carried by the parachute 108 to a target site and may include a payload, payload container, or the UAV/drone itself if in need of recovery. In the example depicted, the object 140 is a container body and the attachment component 136 is a container lid with a set of clips 144-1 and 144-2-1 that engage with a lip on the container body to removably attach the container body to the container lid to enclose a payload. Alternatively, a container lid may be hinged to a container body 140 (Hereafter, clips 144-1 and 144-2 are referred to collectively as clips 144 and generically as clip 144. This nomenclature is used elsewhere herein).

The parachute 108, frame 104, attachment component 136, and container body 140 (if used) may be made of lightweight materials. For example, the frame 104, attachment component 136, and container body 140 may be made mainly of thin plastic. Further, for example, the parachute 108 may include portions made of ultra-high molecular weight polyethylene (e.g., Dyneema®), as will be discussed further below.

The frame 104 may include engagement feature 148 to engage with a complementary engagement feature on an arm that extends from a drone to releasably secure the parachute system 100 to a drone. (Specific, but nonlimiting examples of drones will be discussed in further detail below). Examples of engagement features 148 include an indent, a recess, an undercut, a lip, a protrusion, and similar.

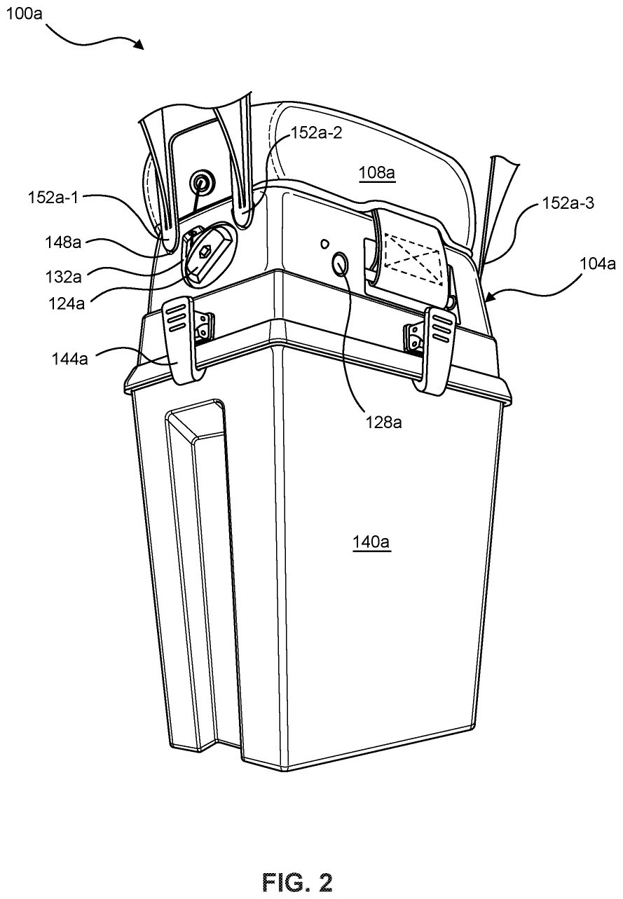

Referring now to FIG. 2, a parachute system in accordance with another embodiment is indicated generally at 100a. Parachute system 100a is a variant on parachute system 100 and thus like elements bear like references except followed by the suffix “a”. Thus, parachute system 100a is substantially the same as parachute system 100, except that parachute system 100a further comprises an attached drone with drone arms 152a, and parachute 108a is shown packed prior to deployment. In the example depicted, the frame 104a includes two indents on each of two opposite sides and opposing drone arms 152a include complementary protrusions to fit into the indents, as shown in FIG. 2.

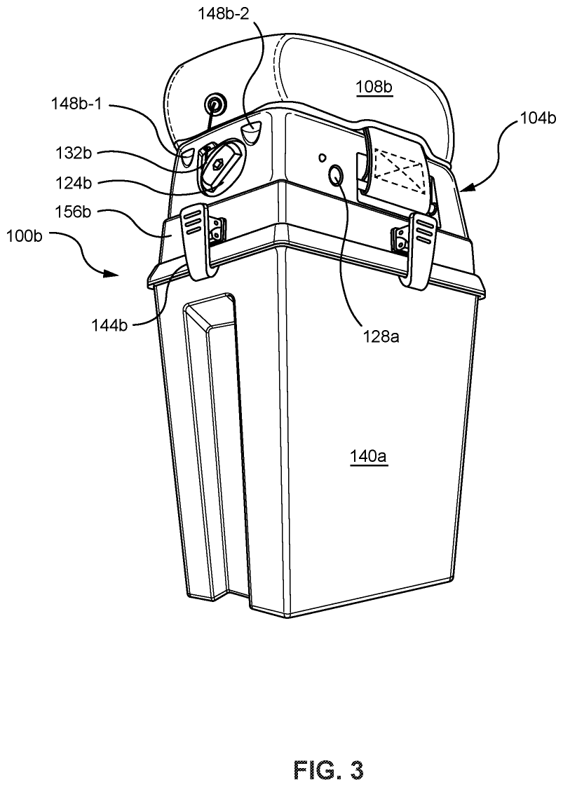

FIGS. 3 to 8 show additional examples of attachment components to secure a payload to a parachute frame to provide controlled and guided delivery of the payload when dropped from a drone.

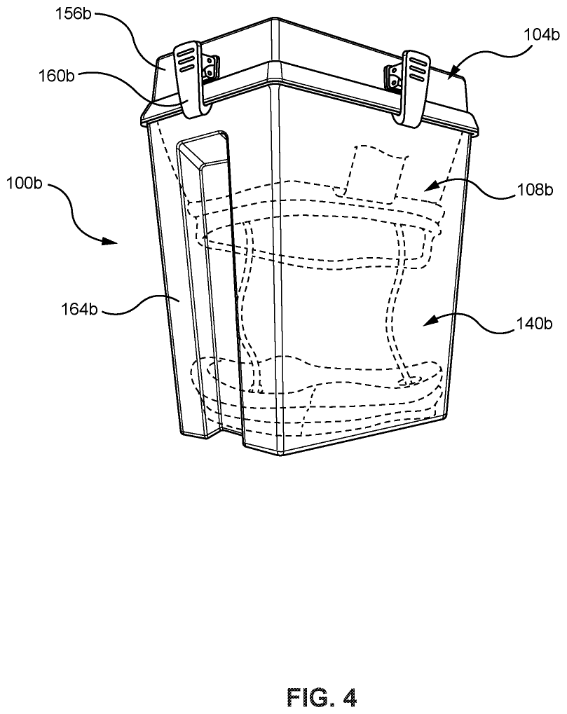

Referring now to FIGS. 3 and 4, a parachute system in accordance with another embodiment is indicated generally at 100b. Parachute system 100b is a variant on parachute system 100 and 100a and thus like elements bear like references except followed by the suffix “b”. Thus, parachute system 100b is substantially the same as parachute system 100 and 100a, except that parachute system 100b further comprises an attachment component that is container lid 156b with a set of clips 144b to secure a container body 140b. The container lid 156b is reversible (e.g., it may be flipped) and the clips 144b may be swivelled 180 degrees to allow storage of a parachute 108b, frame 104b, and components carried by the frame 104b in the container body 140b. FIG. 3 shows the ready configuration, where the parachute system 100b may be connected to a drone or where the parachute system 100b has just been dropped by the drone. FIG. 4 shows the stowed configuration, which may be used before or after payload delivery for storage or transport. In an alternate configuration, the container lid may be hinged openable, thereby allowing for the placement of the parachute into the container after its drop and closing of the lid to secure the parachute inside the container with the lid remaining outside.

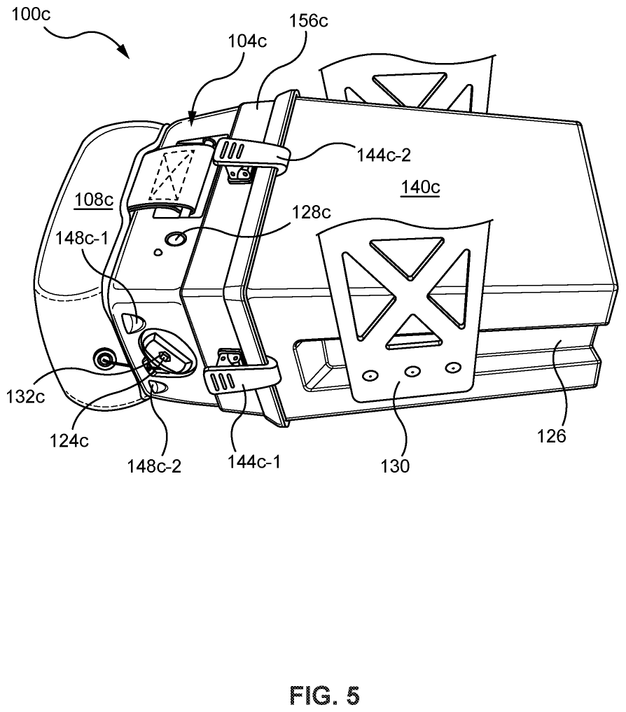

FIG. 5 shows another example parachute system 100c with an attachment component that includes a container body 140c and a set of clips 144c connected to container body 140c. Clips 144c removably attach a container lid 156c to container body 140c to enclose a payload therein. Container body 140c may be connected to a frame 104c that carries a sensor, actuator, and controller and that may be connected to a parachute 508, as discussed elsewhere. Frame 104c and parachute 108c are substantially the same as frame 104, 104a, and 104b and parachute 108, 108a and 108b in FIG. 1, FIG. 2, FIG. 3 and FIG. 4 above.

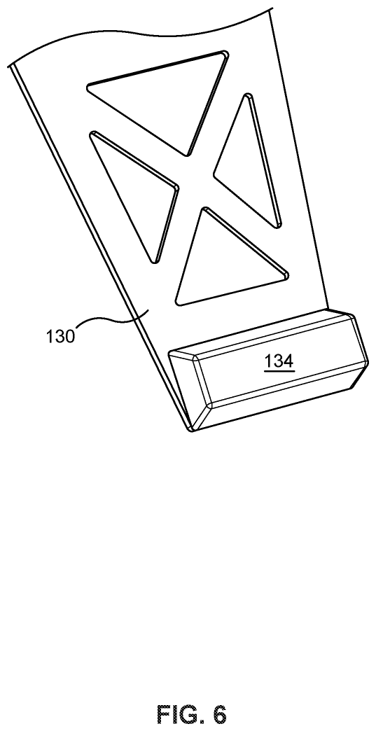

The container lid 156c may include an engagement feature to engage with a complementary engagement feature 134 on a drone arm 130 that extends from a drone to releasably secure the parachute system 100c to the drone, as shown in FIG. 6. In this example, the container lid 156c includes a recess 126 to fit a protruding pad 134 on a drone arm 130. A similar engagement structure may be provided on the opposite side of the parachute system 100c. Other methods for attaching and releasing the parachute system are contemplated, including electromechanical and electromagnetic mechanisms.

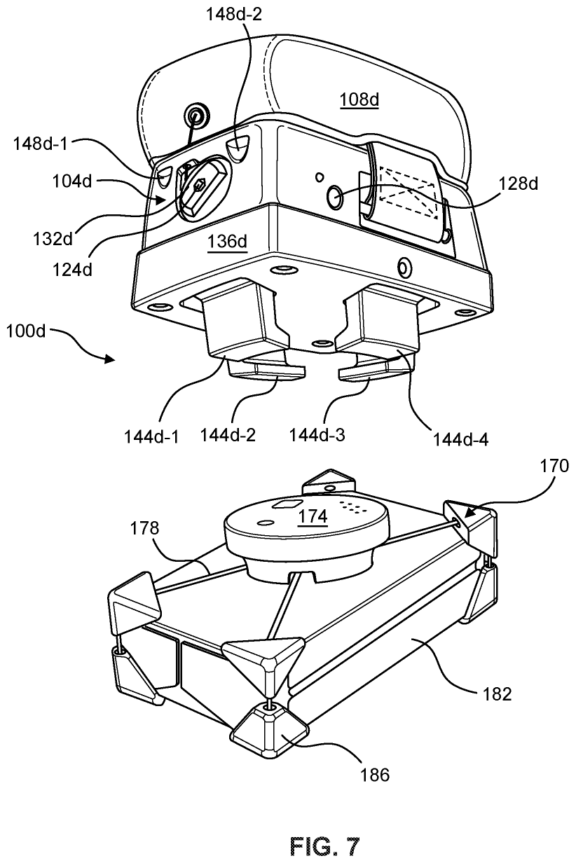

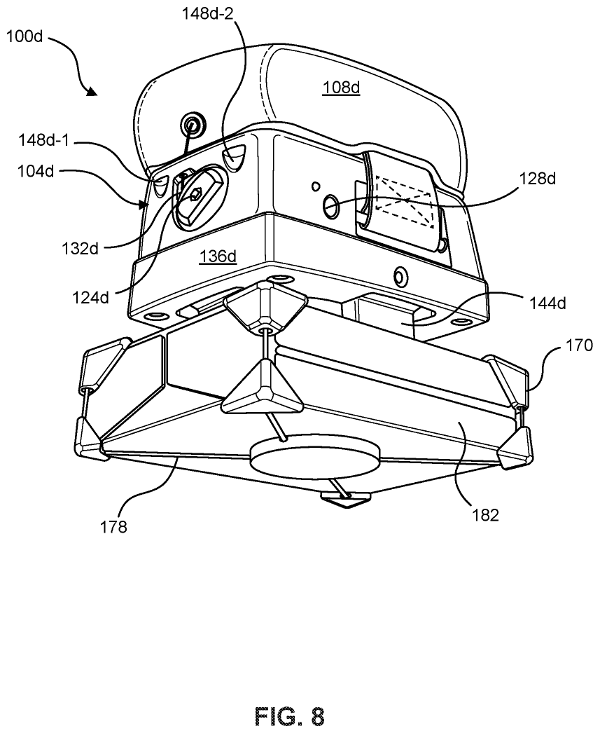

FIG. 7 and FIG. 8 show another example parachute system 100d with an embodiment of an attachment component 136d, that may removably attach to frame 104d and parachute 108d, which are substantially the same as frame 104, 104a, 104b and 104c and parachute 108, 108a, 108b and 108c in FIG. 1, FIG. 2, FIG. 3, FIG. 4, and FIG. 5 respectively, as above. The attachment component 136-d engages with a parcel securement assembly 170. The attachment component 136-d includes a set of opposing clips 144d arranged to engage a protruding knob 174 of the parcel securement assembly 716. The parcel securement assembly 170 may include linear tension members 178, such as rods, cords, wires, or similar, that are arranged to encompass and thus secure a parcel 182. The parcel securement assembly 170 may further include corner brackets 186 attached to the linear tension members 178 to fit over the corners of the parcel 182. The parcel securement assembly 170 may act as a cage or web that secures the parcel 182 and provides the knob 174 for gripping and release by the opposing clips 144d of the attachment component 136d. The knob 174 can additionally contain internally a ratchet mechanism to tension the linear tension members, allowing for secure mounting to a range of parcel sizes and shapes.

The parachute systems discussed above may alternatively be used to provide controlled and guided recovery of a drone that has lost power or malfunctioned or for an intentional powered-off landing.

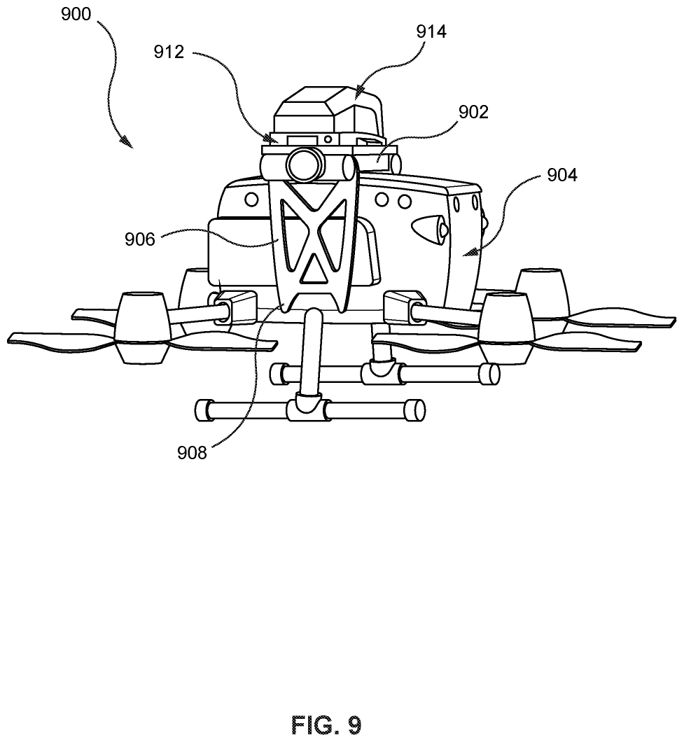

FIG. 9 shows an example parachute system 900 that includes an attachment component 902 that is configured to removably attach to a drone 904. The attachment component 902 may be connected to a frame 912 and parachute 914, as discussed elsewhere herein, to provide guided recovery of the drone 904. The attachment component 902 may include an arm 906 with an engagement feature 908 to engage with a complementary engagement feature on the housing of the drone 904 to removably secure the parachute system 900 to the drone 904.

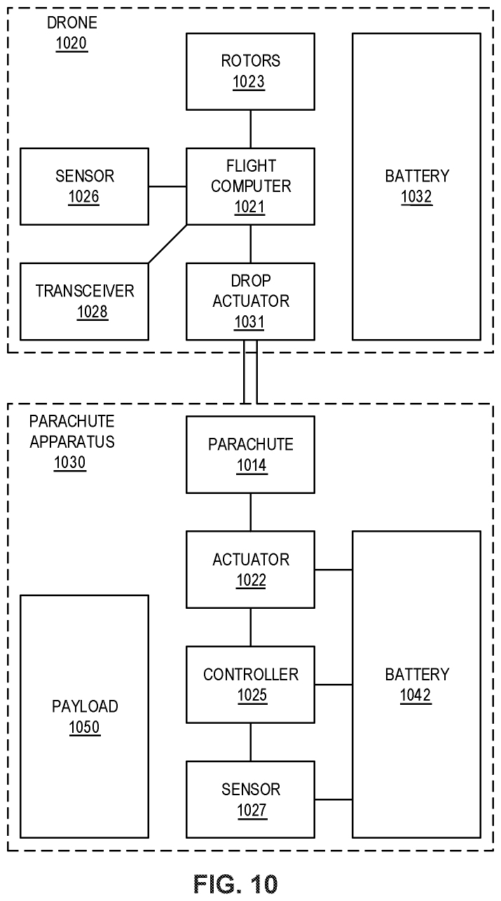

FIG. 10 shows a block diagram of an example drone 1020 carrying an example parachute system 1040 that holds a payload 1050.

The drone 1020 may include a flight computer 1021, rotors 1023, a sensor 1026 (e.g., accelerometer, camera, etc.), a transceiver 1028, a drop actuator 1031, and a battery 1032 to power such components, as needed. The flight computer 1021 controls operations of the drone 1020, such as the rotors 1023, according to a control signal received via the transceiver 1028 and a sensor signal captured by the sensor 1026. The flight computer 1021 may further control the drop actuator 1031 to release the parachute system 1040, for example, by opening carrying arms, to deliver the payload 1050 to a target site.

The parachute system 1040 includes a parachute 1014 that has drop directional control provided by an actuator 1022 via a control line, which may be controlled by a controller 1025 according to a signal received from a sensor 1027, as discussed elsewhere herein. The controller can have the target landing destination, or a multiple optional landing destinations in the case of drone recovery, pre-loaded into the controller 1025 and the sensors can be used to sense the most current information during the event (guided payload or guided drone recovery) as data that may allow override of the original pre-loaded information if its is determined that a correction is needed based on the sensing of the local environment. The parachute system 1040 further includes a battery 1042 to provide electrical power to the actuator 1022, sensor 1027, and controller 1025, as needed.

In examples related to package delivery, the drop actuator 1031 may release the parachute system 1040 from the drone 1020 and trigger deployment of the parachute 1014 and controlled descent of the parachute system 1040. In examples related to drone recovery, the payload 1050 is omitted and the drop actuator 1031 triggers deployment of the parachute 1014 without releasing the parachute system 1040 from the drone 1020. The separate battery 1042 is useful in both applications.

In various examples, the controller 1025 of the parachute system 1040 may be equivalent to the flight computer 1021 of the drone 1020, so as to provide entirely autonomous decent and control independent from a drone.

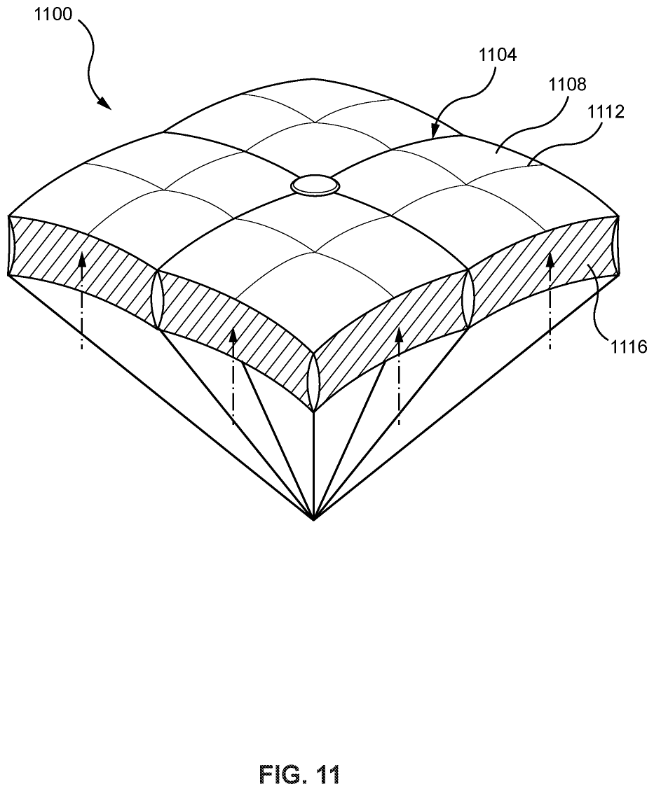

FIGS. 11 to 15 show various examples of parachutes that may be used with the parachute systems discussed above and with other parachute systems. The examples depicted are square parachutes, although other shapes are also suitable, such as round, cruciform, rectangular, curved, the traditional ram-air shape, and so on. The example ram-air parachutes may be made of a first material, such as ultra-high molecular weight polyethylene, and a second material, such as ripstop nylon. The combination of materials, as specific location discussed below, may provide for a lightweight and reliable parachute.

FIG. 11 shows a ram-air parachute 1100 with a canopy structure 1104 formed of a plurality of cells. Any number of cells 1108 may include walls 1112 made of a first material (e.g., ultra-high molecular weight polyethylene) that is relatively light. The canopy structure 1104 includes an inflation portion 1116 made of a second material (e.g., nylon) that is relatively less self-adhering than the first material. That is, the first material has a lower mass per unit area than the second material, and the second material is less self-adhering than the first material. The inflation portion 1116 is positioned at a perimeter of the canopy structure 1104 to initiate inflation (shown by arrows) of the cell 1108 and separation of the walls 1112 made of the first material when the canopy structure 1104 is deployed. That is, the inflation portion 1116 made of second material is less likely to stick together, so as to encourage inflation of the canopy structure 1104, which is made lighter by the use of the first material, which may be too self-adhering to provide a suitable canopy structure by itself.

As shown in FIG. 11, the walls of the first material may include portions of a top and bottom wall of the canopy structure 1104. Further, the inflation portion may include a portion of a side wall of the canopy structure 1104. The remainder of the canopy structure 1104 may be made of the lighter first material.

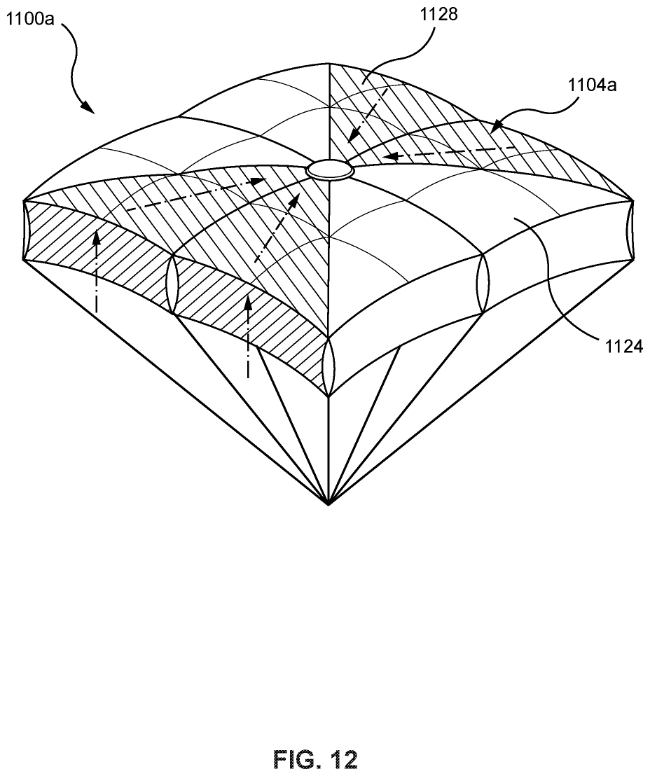

Referring now to FIG. 12, a ram-air parachute in accordance with another embodiment is indicated generally at 1100a. Ram-air parachute 1100a is a variant on ram-air parachute 1100 and thus like elements bear like references except followed by the suffix “a”. Thus, ram-air parachute 1100a is substantially the same as ram-air parachute 1100, except that ram-air parachute further comprises portions of a top and bottom wall that are made of first material may include first triangular portions 1124 having vertices at a center and corners of a canopy structure 1104a. The inflation portion may include second triangular portions 1128 having vertices at the center and corners of the canopy structure 1104a. The second triangular portions 1128 may readily inflate and encourage inflation of the first triangular portions 1124, which may have a tendency to self-adhere. The remainder of the canopy structure 1104a may be made of the lighter first material.

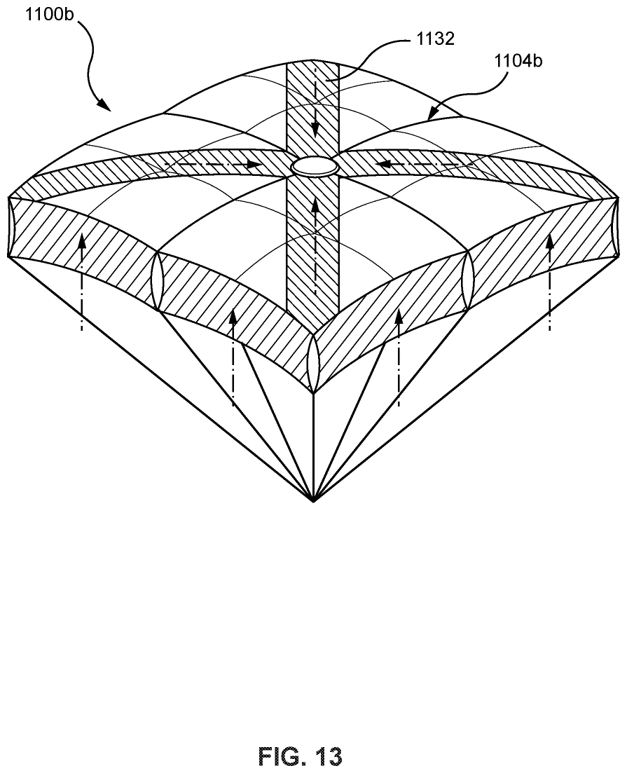

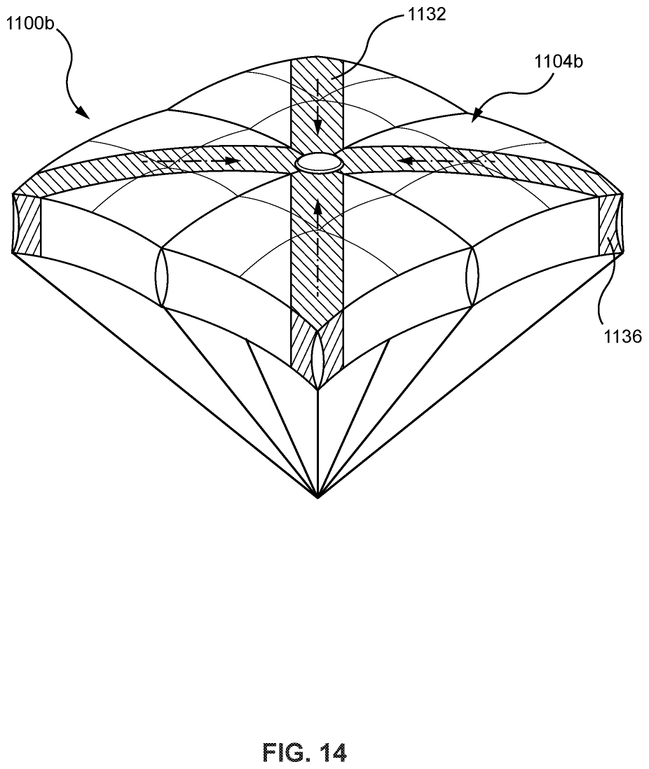

As shown in FIG. 13 and FIG. 14 a ram-air parachute in accordance with another embodiment is indicated generally at 1100b. Ram-air parachute 1100b is a variant on ram-air parachute 1100 and thus like elements bear like references except followed by the suffix “b”. Thus, ram-air parachute 1100b is substantially the same as ram-air parachute 1100, except that ram-air parachute further comprises an inflation portion 1132 of second material may include a linear portion extending between opposite corners of a canopy structure 1104b. An entire perimeter of the canopy structure 1100b may also be part of the inflation portion (FIG. 13) or only a portion, such as the corners 1136, of the canopy structure 1104b may also be part of the inflation portion (FIG. 14). The remainder of the canopy structure 1104b may be made of the lighter first material.

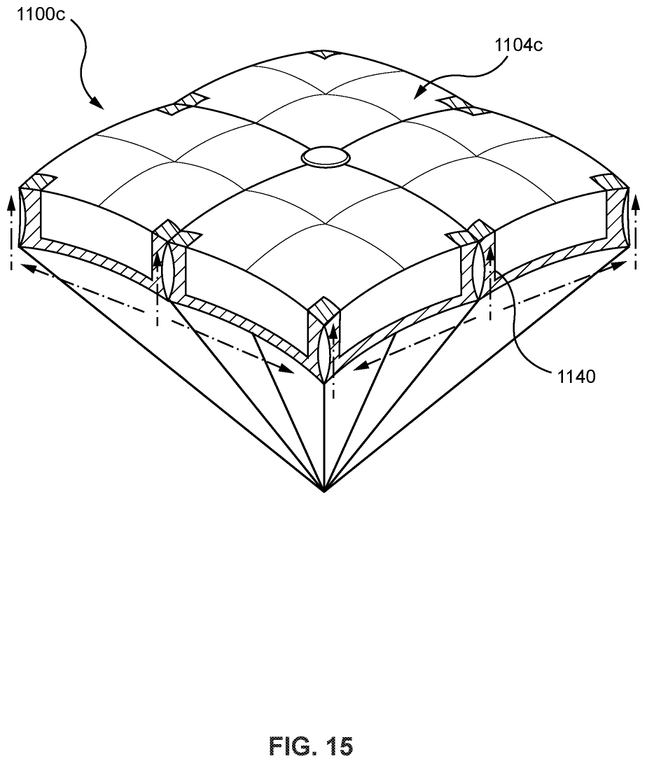

As shown in FIG. 15, a ram-air parachute in accordance with another embodiment is indicated generally at 1100c. Ram-air parachute 1100c is a variant on ram-air parachute 1100 and thus like elements bear like references except followed by the suffix “c”. Thus, ram-air parachute 1100c is substantially the same as ram-air parachute 1100, except that ram-air parachute further comprises an inflation portion of second material may include a middle portion 1140 of the side wall of a canopy structure 1104c. The inflation portion may also include a part of all of the perimeter of the canopy structure 1104c. The remainder of the canopy structure 1104c may be made of the lighter first material.

Additional approaches for increasing the efficiency of the introduction of air between the layers of the lighter first material include the use of calendaring of the first material prior to the assembly and formation into a parachute. Calendaring is the forming of a texture or three-dimensional pattern into the lighter material by the creation of dimples, ridges, or surface offsets. A dimple may be about 1 mm or about 2 mm or about 5 mm in size, for example, and offset by about 1, about 2 or about 10 material thicknesses, for example. The spacing between calendared features can be about every 5 mm or about every 10 mm or greater. The calendared features may be regularly or irregularly arranged. The positioning of the calendared material can be in the same locations as the inflation portions discussed above and generally shown in FIGS. 8-12. The function of the calendared offsets of the parachute material surface is to reduce the self-adhering nature of the first material by way of mechanical offsets that provide small air gaps between adjacent surfaces even when the parachute is packed. Such calendared air gaps form a small pathway for air to enter a cell upon deployment. An entire parachute may be formed from calendared first material, or the calendaring may be used specific areas only, since the downside to the calendared first material is that it does not compact as much as non calendared materials and requires a larger pack volume, and thereby is beneficial to use selectively.

Additional aspects are also disclosed. Sacrificial slip sheets with a low coefficient of friction material may be positioned between layers of lightweight self-adhering (first) material to allow for easy separation. Selective small cut outs or slits through the lightweight self-adhering (first) material, where such cut outs or slits are similarly sized and located as calendared features discussed above, may promote airflow between layers of material for improved deployment. A surface layer may be printed, deposited, or sprayed onto areas of lightweight self-adhering (first) material, where such surface layer includes an anti-static agent that lowers the adhesion between materials to facilitate release at the leading edges to help inflation. Such a material may be included in the polymer composition of the lightweight self-adhering (first) material. A release powder may be applied to the lightweight self-adhering (first) material to decrease its tendency self-adhere.

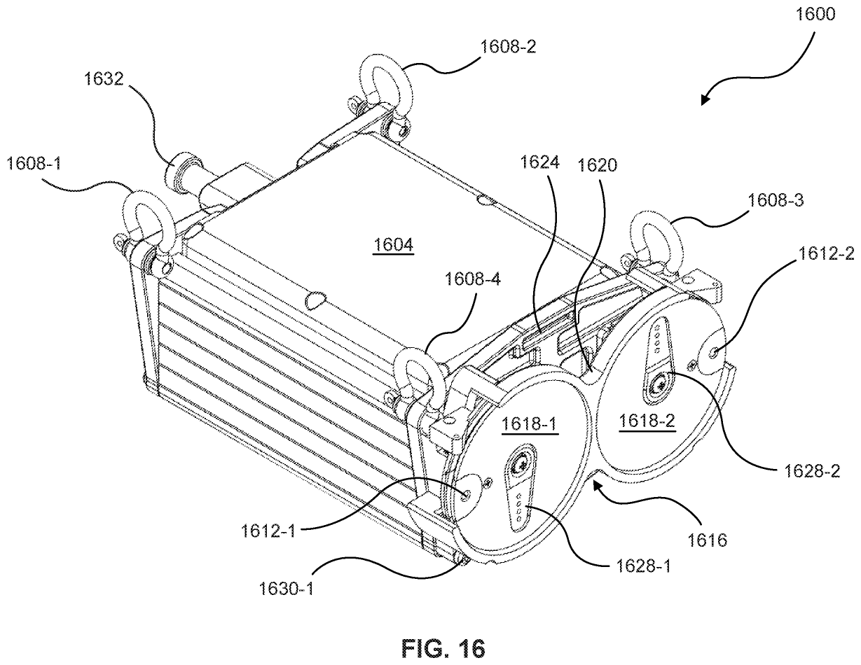

Referring now to FIG. 16, a directional control module in accordance with another embodiment is indicated generally at 1600. Directional control module 1600 comprises an enclosure 1604 connectable to at least one tension element of a parachute (not shown in FIG. 16).

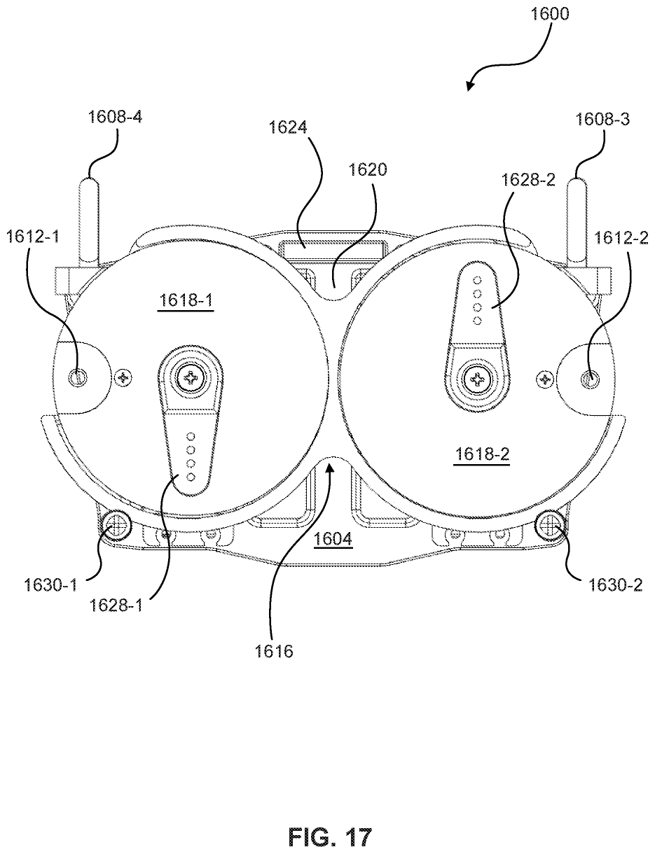

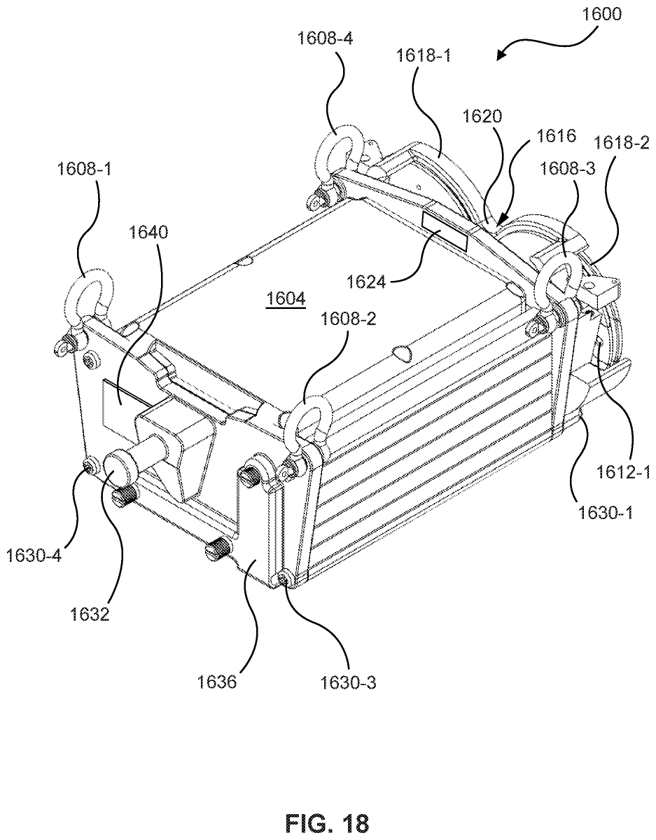

Referring now to FIG. 16, FIG. 17 and FIG. 18 a directional control module in accordance with another embodiment is indicated generally at 1600. Directional control module 1600 can be incorporated into either a parcel delivery or a drone recovery system in accordance with the teachings elsewhere herein. For example, a person of skill in the art will recognize that directional control module 1600 can serve as frame 104 of parachute system 100 or in variants of parachute system 100.

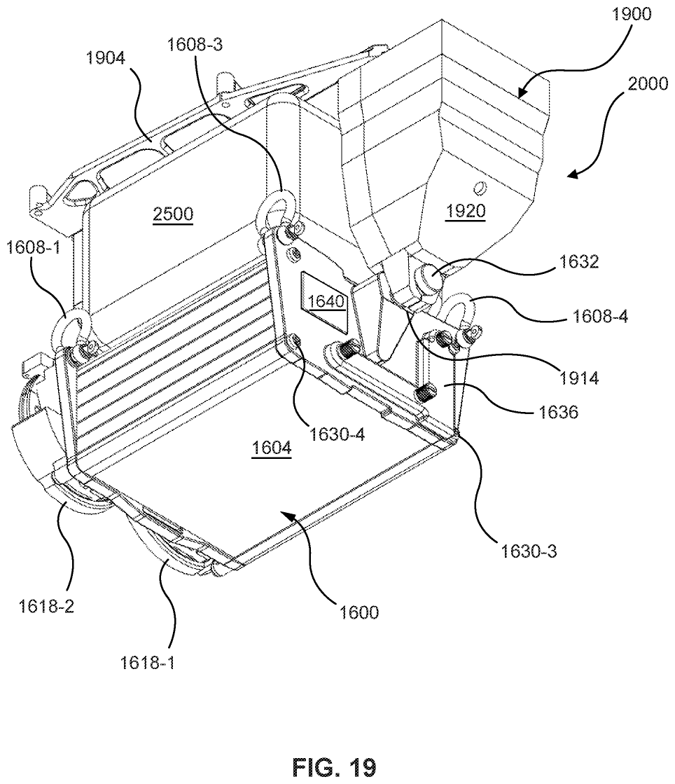

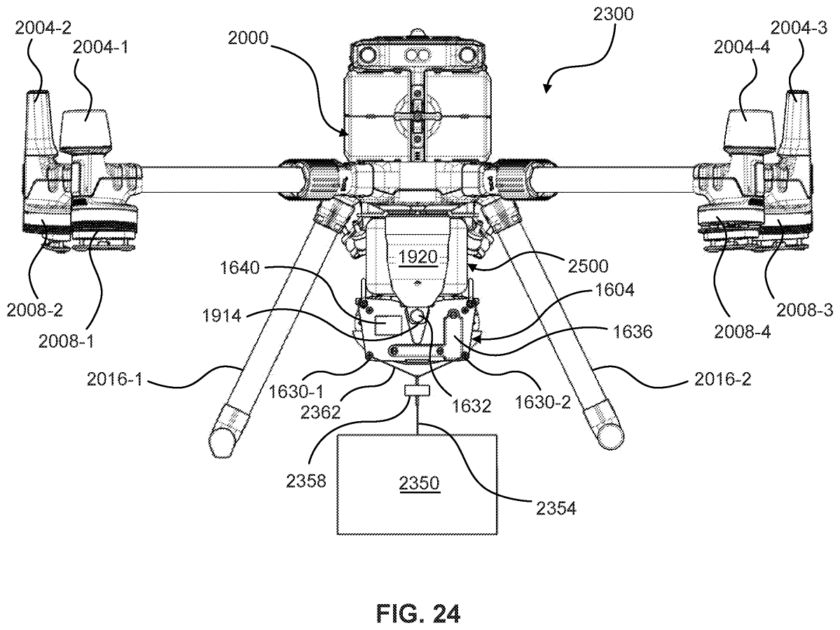

Directional control module 1600 is characterized by an enclosure 1604 that supports a plurality of shackles 1608. Shackles 1608 are configured to secure tension elements for a parachute, such as set of lines 112 on parachute system 100 or in variants of parachute system 100. Enclosure 1604 further comprises an aperture 1624, which is used to secure a drop module 1900 onto directional control module 1600. (Drop module 1900 will be discussed in further detail below in relation to FIG. 19.) Enclosure 1604 further comprises a plurality of fasteners 1630, which are used to secure a swivel 2358 and payload 2350 to enclosure 1604. (Swivel 2358 and payload 2350 will be discussed in further detail below in relation to FIG. 24). In the present embodiment, a locking pin 1632 is disposed on the end of enclosure 1604 that is opposite to aperture 1624. Aperture 1624 and locking pin 1632 are complementary to attachment points on drop module 1900 for releasable attachment to directional control module 1600. As best seen in FIG. 18, enclosure 1604 further comprises a battery cover 1636 and a display screen 1640. In exemplary embodiments, display screen 1640 is an organic light emitting device (OLED) display, which displays characteristics about the system, including but not limited to the state of the onboard sensors, and the status of the system as a whole. Persons skilled in the art will recognize that display screen 1640 can be another type of display instead of an OLED display.

As best seen in FIG. 16 and FIG. 17, actuator 1616 comprises at least one servo pulley 1618 surrounded by a fender 1620. Fender 1620 leaves an exposed portion of the pulleys 1618 at the peripheral edge of enclosure 1604. Servo pulleys 1618 are mechanically keyed to receive a respective servo arm 1628. Servo pulleys 1618 each include a respective control line mount 1612. Each mount 1612 is connectable to a respective control line 120 on parachute system 100 or variants of parachute system 100. Servo pulleys 1618 are responsive to control signals received by a controller (such as controller 1025), which in turn receives signals from a sensor (such as sensor 1027) for determining a target site. Note that the sensor and controller are not shown herein but are housed within enclosure 1604. Other ways of implementing actuator 1616 will now occur to those skilled in the art.

Servo pulleys 1618 are configured to turn, bi-directionally, according to rotational forces applied to a respective servo arm 1628 via servo motors (not shown) housed within enclosure 1604 that receive instructions from the controller 1025. Control lines 120 are attached to actuator 1616 through control line mounts 1612 and are displaced responsive to a signal processed by directional control module 1600, thus modifying the shape of the attached parachute and causing the parachute to be steered in the desired direction toward the target site. Accordingly, minute changes to the angular position of each control line mount 1612 can achieve the desired directional control of the parachute.

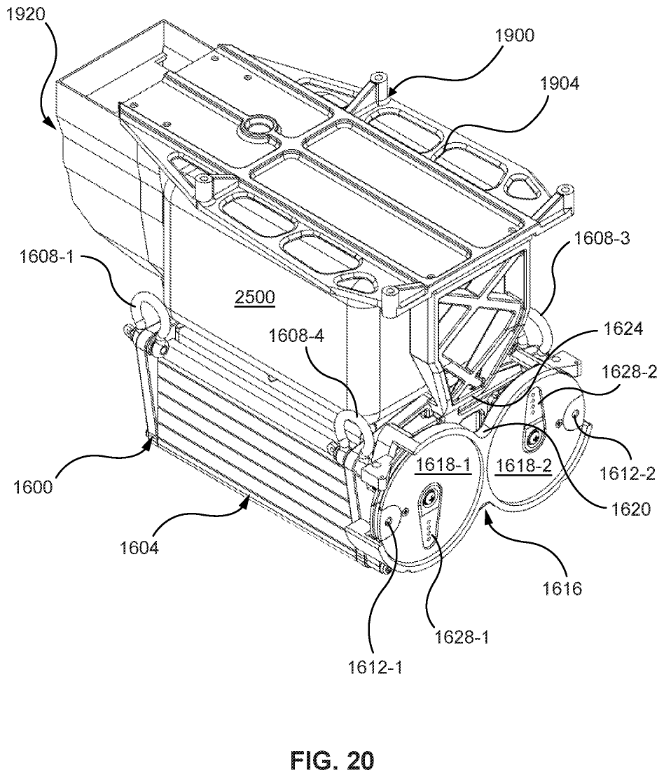

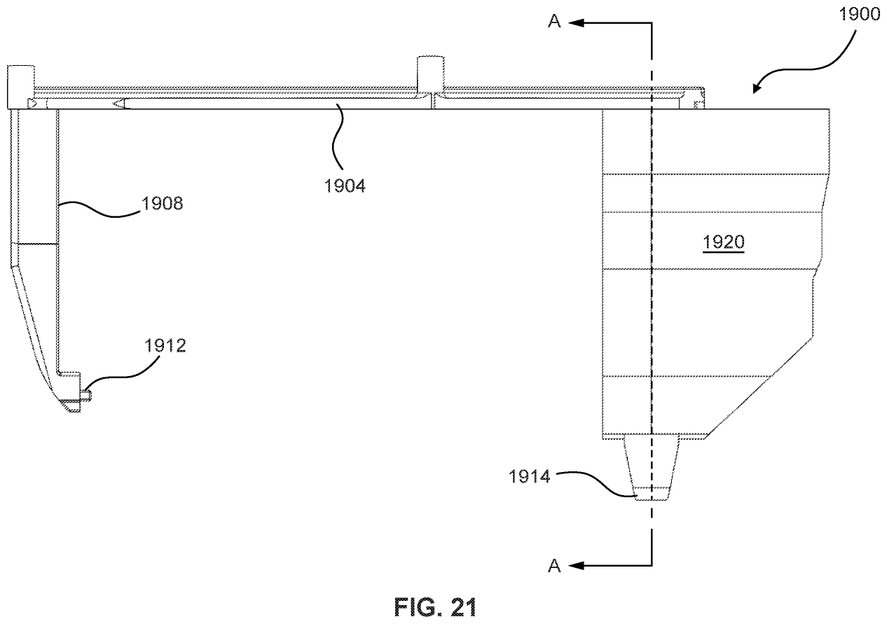

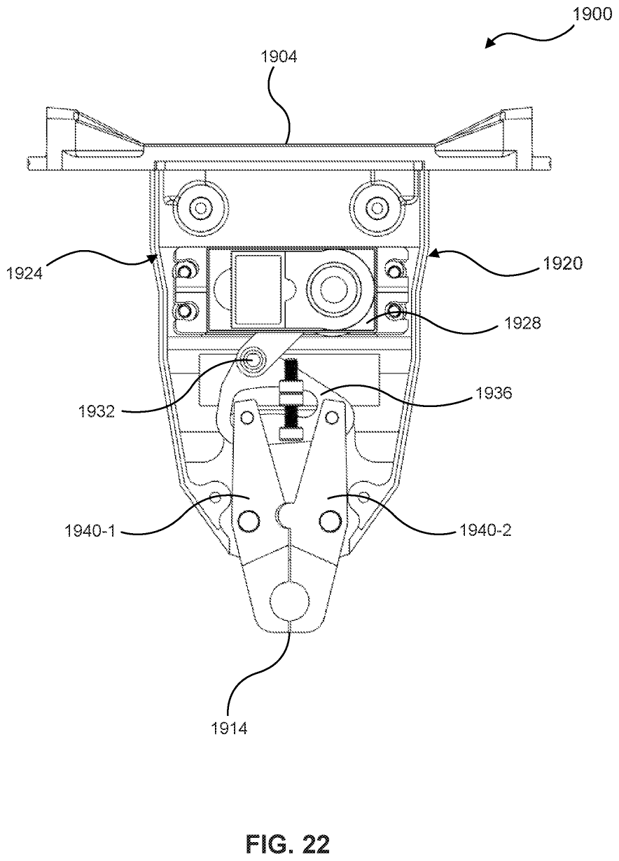

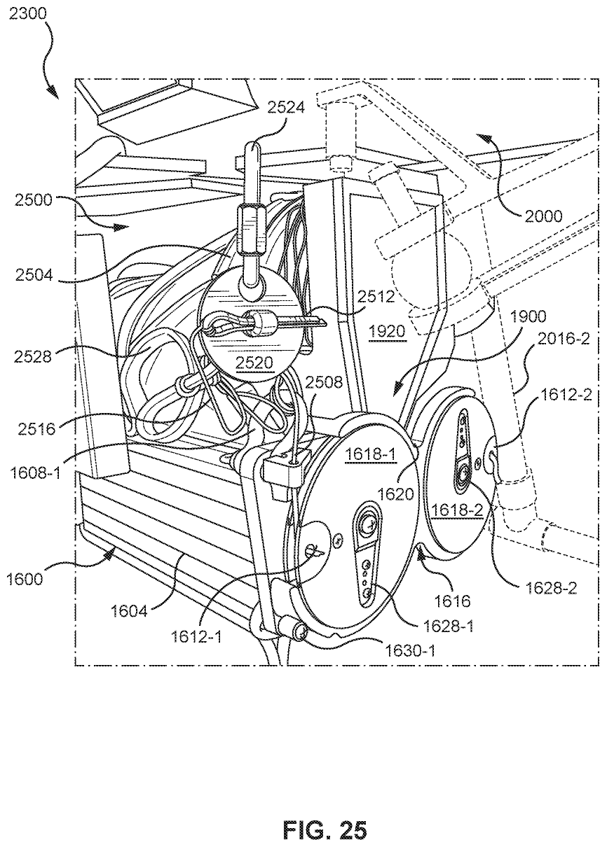

Referring now to FIG. 19 and FIG. 20, a drop module 1900 is shown connected to directional control module 1600 and a parachute pod 2500. (Parachute pod 2500 is described in greater detail in FIG. 25) FIGS. 21 and 22 show drop module 1900 in isolation from directional control module 1600 and parachute pod 2500. FIG. 22 is a sectional view of drop module 1900 along the plane A-A in FIG. 21.

Referring now to FIG. 19, FIG. 20, FIG. 21, and FIG. 22, drop module 1900 comprises a mounting bracket 1904 for attachment to a drone. (The choice of drone is not particularly limited and can include exemplary drone 1020 or other suitable drones discussed elsewhere herein, or other drones as will occur to those skilled in the art.) As best seen in FIG. 21, a securing wall 1908 is provided that retains directional control module 1600 and parachute pod 2500. Securing wall 1908 includes a tab 1912 complementary to aperture 1624 and for insertion into aperture 1624 on directional control module 1600 to secure drop module 1900 directional control module 1600. Drop module 1900 also includes a jaw 1914 which is configured to releasably secure locking pin 1632.

Drop module 1900 also includes a drop module control unit housed within chassis 1920 disposed between mounting bracket 1904 and jaw 1914. Chassis 1920 houses components of drop module 1900 that move jaw 1914 between an open position for releasing locking pin 1632 and a closed position for securing locking pin 1632. The components housed within chassis 1920 are shown in greater detail in FIG. 22.

As best shown in FIG. 22, chassis 1920 comprises a drop servo 1928, which is configured to control jaw 1914 through a series of movements throughout the elements of chassis 1920. Expressed in greater detail, drop servo 1928 controls a rotating link 1932 and a cam 1936, resulting in the rotating movement of scissor links 1940, thereby opening and closing of jaw 1914. In FIG. 22, jaw 1914 is shown in a closed position for grasping locking pin 1632 on directional control module 1600. The drop module control unit within chassis 1920 may be commanded through either a telecommunications device on control unit within chassis 1920 (not shown) or on the ground, or it may receive a control signal within the electronics of the drone. For example, a suitably modified drop actuator 1031, under the control of flight computer 1021, as previously discussed in relation to FIG. 10 can be incorporated into control unit within chassis 1920.

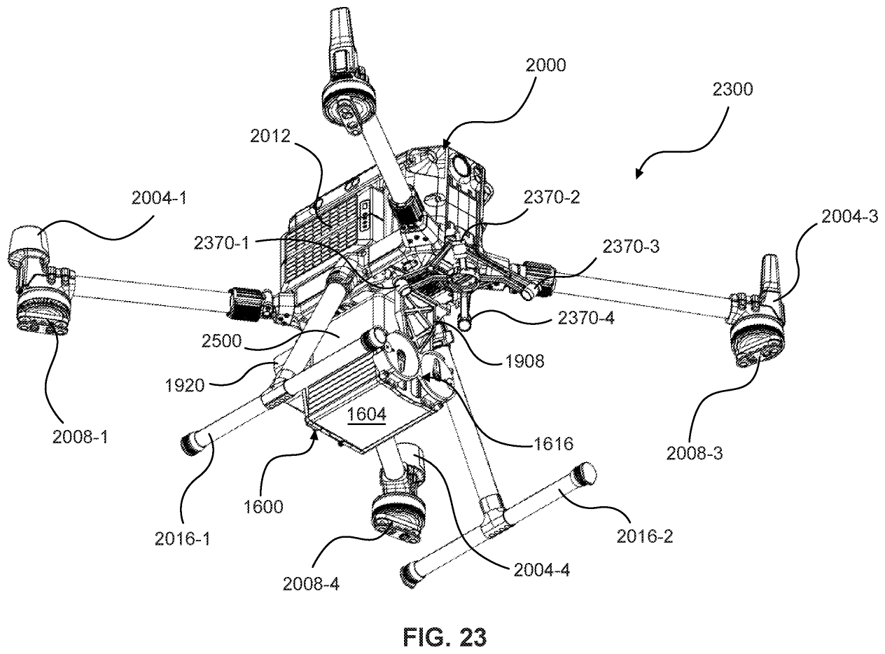

Referring now to FIG. 23 and FIG. 24, another embodiment of a payload delivery system 2300 is shown, including a drone 2000 connected to drop module 1900, parachute pod 2500, and directional control module 1600. Drone 2000 is a variant on drone 1020. Drone 2000 comprises sensors 2004, propeller mounts 2008, a flight computer 2012, drone legs 2016, and other elements that are common to drone 1020, such as a drop actuator (not shown), a transceiver (not shown), a set of rotors (not shown) and a battery (not shown).

FIG. 24 shows a back view of system 2300 with payload 2350 attached. Payload 2350 is connected to an attachment component 2354, which may be a rope, a line, or any linear tension members that may be used to secure payload 2350. Attachment component 2354 is secured to swivel 2358, which is connected to a second attachment component 2362, which is attached to fasteners 1630 on enclosure 1604. Attachment component 2354, swivel 2358 and second attachment component 2362 are collectively referred to as parcel securement assembly 2364. Attaching payload 2350 in this configuration allows it to rotate freely without interference on the dynamics of the payload delivery system 2300.

Referring now to FIG. 25, a partial isometric view of payload delivery system 2300 is shown. Parachute pod 2500 contains a packed parachute 2504 (which is a variant on parachute 108). Parachute 2504 has a control line 2508 that is secured to control line mount 1612. A cotter pin 2512 holding a main parachute line 2516 (substantially the same as line 112) and disk 2520 are secured to securing wall 1908 through a coupling mechanism 2524. Coupling mechanism 2524 may be a carabiner, or a quick link as shown in FIG. 25, made of metal or any other material that will be apparent to a person of skill in the art. Static line 2528 is wraps around cotter pin 2512 and is inserted through a hole in disk 2520.

In operation, in the case of payload delivery, the controller within directional control module 1600 will respond to signals from the sensor to calculate the reachability of the desired location (also referred to herein as the target site) based on factors including but not limited to glide ratio and descent rate. Drop module 1900 will then release parachute pod 2500 and directional control module 1600 based on the signal from the controller, and parachute 2504 will deploy from parachute pod 2500. Upon release from drop module 1900, static line 2528 experiences tension from descent, until a level of tension is reached so that pin 2512 is released from static line 2528, thereby completely releasing parachute line 2516. Lines 2516 experience tension until parachute 2504 releases completely from parachute pod 2500. Once free, parachute deploys providing a controlled descent. Parachute 2504, along with directional control module 1600, carrying payload 2350, will then begin to steer towards the desired target site.

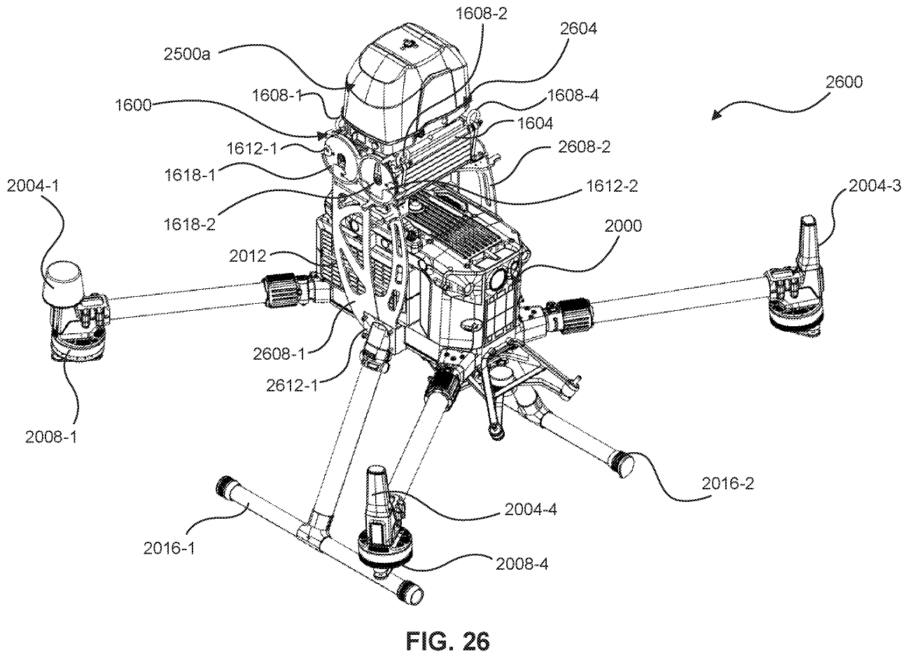

Referring now to FIG. 26, a drone recovery system 2600 is shown. Drone recovery system 2600 comprises drone 2000, mounted to a plate (not shown) on the bottom of directional control module 1600 that slots into a plurality of mounting brackets 2608 (a variant on attachment component 902), onto which a deployment mechanism 2604 is mounted, connected to parachute pod 2500a (which is a variant of parachute pod 2500). Deployment mechanism 2604 is connected to parachute pod 2500a through a bolt secured to parachute pod 2500a (not shown). Deployment mechanism 2604 comprises a spring or pyrotechnic mechanism that triggers deployment of parachute 2504a without release from drone 2000 which are used to removably attach to a drone 2000. A plurality of drone leg mounts 2612 are used to secure drone legs 2016 to drone recovery system 2600.

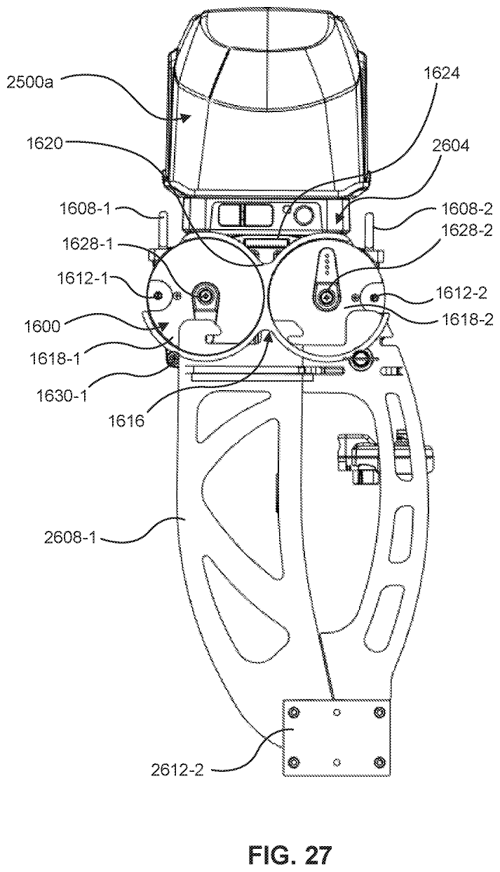

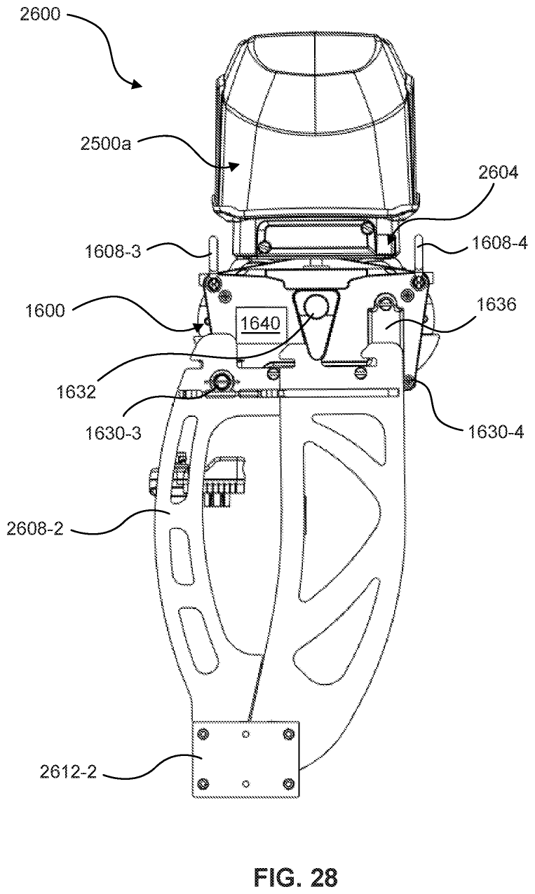

FIGS. 27 and 28 show a first and second side view (independent from drone 2000) of mounting brackets 2608 mounted to directional control module 1600, which is attached to deployment mechanism 2604 and parachute pod 2500a.

In operation, in the case of drone recovery, the target site either may be pre-programmed into directional control module 1600 or sent to drone recovery system 2600 via telecommunication, or drone recovery system 2600 may select a location based on a machine vision algorithm Drone failure is detected either by the sensor within directional control module 1600, or through a manual message sent to the controller within directional control module 1600 to terminate flight of the drone by disarming its motors. The controller within directional control module 1600 will then communicate with deployment mechanism 2604 to deploy parachute 2504a. Directional control module 1600 will then steer system 2600 to the desired target location.

While the foregoing describes certain embodiments, it is to be understood the combinations, variants, and subsets are contemplated. For example, directional control module 1600 can be one way of implementing actuator 1022, controller 1025, sensor 1027 and battery 1042 of parachute apparatus 1030 from FIG. 10. However, a person of skill in the art will understand that directional control module 1600 can be configured to operate with variants on parachute apparatus 1030.

The steerable parachute system disclosed herein may be applied to enhance risk assessment and mission planning for UAV. Mission planning occurs prior to the flight and consists, in part, of establishing a desired flight path. The steerable parachute system disclosed herein provides a means of selecting suitable emergency landing zones along a flight path prior to the flight. These suitable landing zones can be pre-programmed into the parachute system and in the case of an emergency, the system will steer towards the closest pre-selected landing zone. The system will calculate in real-time if this landing zone is reachable based on the wind speed, wind direction, known estimates of the glide ratio of the parafoil and other criteria. The steerable parachute system may also use machine learning algorithms to autonomously determine suitable landing areas. These algorithms select landing areas based on sensor data, either images, Light Detection and Ranging (LiDAR), or other sensors. The algorithm may process images or other sensor data, and extract features to classify and rank different landing areas based on the risk of harm, damage to property or other suitable criteria. After classifying landing areas, the algorithm will localize the system and send a signal to the controller to determine which direction to steer the parachute.

The steerable parachute system may be used in environments that do not allow for satellite-based navigation. The system may use sensors such as cameras, LiDAR, inertial measuring units, or a combination of such sensors, to localize itself along a route. The use of simultaneous localization and mapping algorithms along with these sensors may be used to measure the position of the system relative to a known reference frame. This system allows for navigation and controlled flight in environments such as tunnels, buildings, and other areas with insufficient satellite signals.

Most existing parachute systems for drones are uncontrolled, making the systems susceptible to drift in the wind towards potentially undesirable landing areas. Systems that employ some level of controlled descent use aerodynamic fins and a traditional parachute. These systems are heavier and do not provide the advantage of lower descent rates that are afforded by ram-air parachutes.

Having described various embodiments, a person of skill in the art will now appreciate the full scope of the invention according to the attached claims.

1. A steerable parachute system for use with a drone comprising:
a directional control module comprising:
an enclosure supporting:
a sensor for capturing a signal associated with a target site;
a controller connected to the sensor for determining a direction of travel in response to the signal; and
an actuator responsively coupled to the controller;
an attachment component for securing a payload to the enclosure; and
the parachute connectable to the directional control module, the parachute having a plurality of tension elements, at least one of the tension elements being connected to the actuator for steering the parachute during controlled descent towards a location relative to the target site.

2. The steerable parachute system of claim 1 wherein the payload is the drone.

3. The steerable parachute system of claim 1 wherein the payload is a parcel.

4. The steerable parachute system of claim 1, further comprising a drop system; the drop system comprising:
a mounting bracket for securing to the drone;
a chassis depending from a first side of the mounting bracket for supporting a drop system control module and a jaw for releasably securing a first side of the directional control module;
a securing arm depending from the opposite side of the mounting bracket to secure the opposite side of the directional control module.

5. The steerable parachute system of claim 3 wherein the attachment component comprises at least one linear tension member for securing said parcel.

6. The steerable parachute system of claim 5 further comprising a swivel so that said parcel can rotate freely independently from the directional control module.

7. The steerable parachute of claim 2, further comprising a recovery system; the recovery system comprising:
a deployment mechanism that deploys upon detection of drone failure, the deployment mechanism being attached to the directional control module and the parachute; and
at least one mounting bracket to secure the directional control module to the drone;
wherein parachute system is to provide guided recovery of the drone.

8. The steerable parachute of claim 7, wherein the deployment mechanism comprises a spring.

9. The steerable parachute of claim 7, wherein the deployment mechanism comprises a pyrotechnic mechanism.

10. A directional control module comprising:
an enclosure supporting:
a sensor for capturing a signal associated with a target site;
a controller connected to the sensor for determining a direction of travel in response to the signal; and
an actuator responsively coupled to said controller and connectable to at least one tension element of a parachute for controlling descent towards a location relative to the target site.

11. The directional control module of claim 10, wherein the actuator comprises at least one servo pulley.

12. The directional control module of claim 10, wherein the enclosure comprises at least one shackle for securing at least one of said tension elements on the parachute.

13. A ram-air parachute comprising:
a canopy structure formed of a plurality of cells;
wherein a cell of the plurality of cells includes walls of a first material;
the canopy structure further including an inflation portion made of a second material;
wherein the first material has a lower mass per unit area than the second material;
wherein the second material is less self-adhering than the first material; and wherein the inflation portion is positioned at a perimeter of the canopy structure to initiate inflation of the cell and separation of the walls made of the first material when the canopy structure is deployed.

14. The ram-air parachute of claim 13, wherein:
the walls of the first material include portions of a top and bottom wall of the canopy structure; and
the inflation portion comprises a portion of a side wall of the canopy structure.

15. The ram-air parachute of claim 14, wherein:
the portions of a top and bottom wall of the canopy structure include first triangular portions having vertices at a center and corners of the canopy structure; and
the inflation portion further includes second triangular portions having vertices at the center and corners of the canopy structure.

16. The ram-air parachute of claim 14, wherein the inflation portion further includes a linear portion extending between opposite corners of the canopy structure.

17. The ram-air parachute of claim 14, wherein the inflation portion comprises a corner portion of the side wall of the canopy structure.

18. The ram-air parachute of claim 14, wherein the inflation portion comprises a middle portion of the side wall of the canopy structure.

19. The ram-air parachute of claim 14, wherein the inflation portion comprises an entire side wall of the canopy structure.

20. The ram-air parachute of claim 14, wherein the first material comprises ultra-high molecular weight polyethylene.

21. The ram-air parachute of claim 14, wherein the second material comprises nylon.

22. A parachute comprising a first portion of a first material and an inflation portion of the first material, wherein the first material is self-adhering, and wherein at least some of the inflation portion is calendared.

23. The steerable parachute system of claim 4 wherein the attachment component comprises at least one linear tension member for securing said parcel.
